(19) United States
(12) Patent Application Publication
(10) Pub. No.: US 2007/0045968 A1
(43) Pub. Date: Mar. 1, 2007

(54) Pipe gasket

(75) Inventors: Dwight C. Long, Littleton, MA (US); Louis C. Bongiorno, Millington, NJ (US)

Correspondence Address: PROSKAUER ROSE LLP, ONE INTERNATIONAL PLACE 14TH FL, BOSTON, MA, 02110, US

(73) Assignee: Integra Companies, Inc.

(21) Appl. No.: 11/220,001

(22) Filed: Aug. 31, 2005

(51) Int. Cl. F16L 17/06

(52) U.S. Cl. 277/608

(57) ABSTRACT

A pipe gasket for providing a sealing between a pair of sanitary pipes, each pipe including a pipe flange having a grooved face and an outer face. The pipe gasket can be fixedly attached to one pipe flange to facilitate ease in assembly and to also provide proper seal alignment. The pipe gasket includes a support element having at least two protrusions extending from an outer circumference toward an inner circumference, each protrusion for cooperatively engaging the outer face of at least one of the pipe flanges and a sealing element formed with the support element to provide a fluid tight seal between the pair of sanitary pipes.

### BACKGROUND OF THE INVENTION

Plants processing foods, pharmaceuticals, biological and technological fluid materials generally require fluid piping systems that must be free from voids and crevices to prevent accumulations of materials. A typical fluid piping system includes multiple sections of pipe or tubing coupled together. To that end, each coupling joint of the system is of particular importance because it must provide a bacteria-tight seal without obstructing the flow of the material.

A coupling joint typically includes a pair of pipe ends having respective flanges, a gasket, and a fastening device. To assembly the coupling joint, care must be taken to ensure the gasket is properly seated between the pair of pipe ends. Improper seating of the gasket can lead to an improper seal. Further, in instances where too little contact pressure is applied by the fastening device, valleys in the inner diameter of the coupling joint surface will not be adequately filled by the gasket material to prevent accumulation of microorganisms. Furthermore, in instances where too much contact pressure is applied, the gasket material may be extruded into the pipe lumen thereby causing an obstruction or partial dam that could cause material to be trapped.

### SUMMARY OF THE INVENTION

Many types of pipe gasket exist today, the vast majority of which are manufactured from elastomeric materials. When fitting/seating such gaskets between pipe ends of a pipe joint, it can be very difficult to keep the soft elastomer in position to ensure that it accurately forms a quality seal between the two pipe ends as the pipe ends are closed together. In practice, it is often impossible to tell whether the gasket is correctly aligned with the pipe ends following tightening of a pipe joint without first testing the integrity of the pipe joint by pressure testing the pipe bore itself. Further, it is difficult to hold the gasket in place when joining the two pipe ends. Furthermore, should the gasket fall off of the assembly, it can become contaminated. As such, assembly is clearly time consuming and can be expensive.

The present invention provides a pipe gasket for providing a seal between a pair of pipes, each pipe including a pipe flange having a grooved face and an outer face. The pipe gasket can be fixedly attached to one pipe flange to facilitate ease in assembly and to also provide proper seal alignment. The gasket includes a support element having at least two protrusions extending from an outer circumference toward an inner circumference, each protrusion for cooperatively engaging the outer face of at least one of the pipe flanges and a sealing element formed with the support element to provide a fluid tight seal between the pair of pipes.

According to one aspect, the support element defines a plurality of holes in close proximity to the inner circumference, outer portions of the sealing element couples through the holes. The holes can be evenly spaced around the inner circumference of the support element. The support element can be made from metal, plastic, or other suitable material and can be color-coded.

In one embodiment, the support element includes three inwardly directing protrusions. Each protrusion can be evenly spaced about the outer circumference of the support element. Further, each protrusion can have a width of between 1 and 49 percent of the outer circumference of the support element, and preferably approximately sixteen percent of the outer circumference of the support element. Furthermore, each protrusion can extend inwardly between 1 and 89 degrees from the outer circumference of the support element, and preferably approximately eight degrees from the outer circumference of the support element. Each protrusion can also include an engagement portion for engaging an outer face of at least one of the pipe flanges. The protrusions can include a surface for placing indicia representative of the pipe gasket.

The sealing element includes an alignment portion for aligning respective grooved faces of each pipe flange. The alignment portion can be an O-ring. The sealing element can be made from an elastomer. The elastomer can be an ethylene propylene diene monomer, a fluoroelastomer, or a perfluoroelastomer.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a cross-sectional side view of an embodiment of a pipe gasket of the present invention in engagement with a first pipe flange;

FIG. 1B is a cross-sectional side view of the embodiment of FIG. 1A in connection with a second pipe flange;

FIG. 1C is a cross-sectional side view of the embodiment of FIG. 1B coupled together;

FIG. 2A is a plan view of an embodiment of a pipe gasket of the present invention;

FIG. 2B is a cross-sectional side view of an embodiment of a pipe gasket of the present invention;

FIG. 2C is a cross-sectional exploded view of a gripper portion of the support element of FIGS. 2A and 2C;

FIG. 2D is a cross-sectional exploded view of a support element of FIGS. 2A and 2C;

FIG. 3A is a plan view of another embodiment of a pipe gasket of the present invention;

FIG. 3B is a cross-sectional side view of another embodiment of a pipe gasket of the present invention;

FIG. 3C is a cross-sectional exploded view of a gripper portion of the support element of FIGS. 3A and 3B; and

FIG. 4 is a flow diagram for a process of making a pipe gasket of the present invention.

### DETAILED DESCRIPTION OF THE INVENTION

A description of preferred embodiments of the invention follows.

Generally, the present invention is directed toward a mechanism for retaining a pipe gasket on a pipe end during a pipe joint assembly process. The present invention also provides the following features: 1) proper seal alignment of the pipe gasket between the pipe joint; 2) a mechanical stop to prevent over-tightening of the pipe gasket; 3) color-coding and indicia marking means for preventive maintenance, material identification, and application identification purposes. The pipe gasket of the present invention should adhere to the Bioprocessing Equipment ASME BPE Standards. It should be understood by one skilled in the art that an form of “pipe” is synonymous with any form of “tube.”

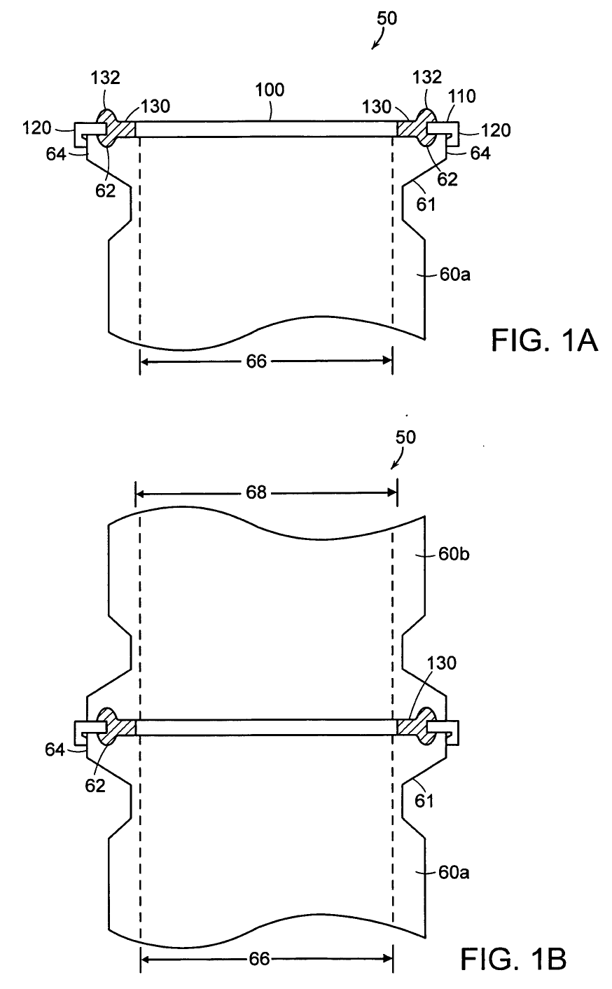

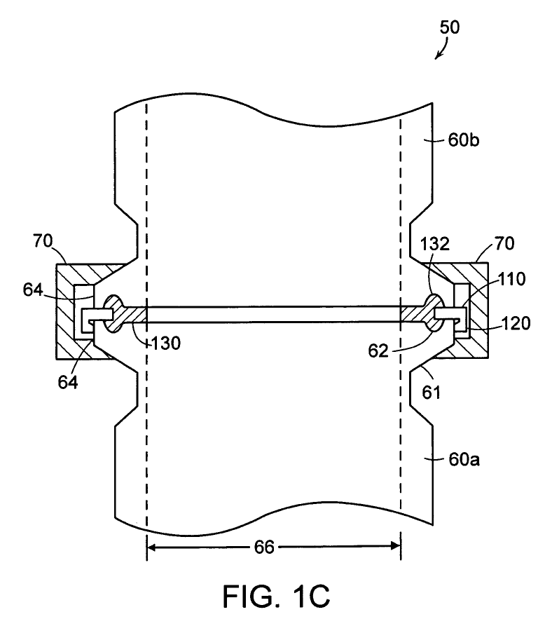

FIGS. 1A-1C show a cross-sectional assembly 50 process for joining two sanitary pipe fittings 60a, 60b. Each sanitary pipe fitting 60a, 60b includes a flange 61, a recess or annular groove 62, an outer face 64, and an inner diameter (ID) 66. The flange 61 may be of the type designed to cooperate with a conventional hinged clamp 70 for securing the assembly 50. A pipe gasket 100 of the present invention is used to provide a bacterial-tight seal between the two sanitary pipe fittings 60a, 60b.

The pipe gasket 100 includes a support element 110 and a sealing element 130. The support element 100 include at least two protrusions 120 for coupling the gasket to either pipe fitting 60a, 60b. The protrusions 120 extend from the outer circumference toward the inner circumference of the support element 110 and cooperate with each other to provide sufficient retaining force against the outer face 64 of either pipe fitting 60a, 60b.

The support element 110 can be manufactured in one piece from engineering plastics material, such as polyphenylsulfone (Radel), metal, or other material known in the art.

In a preferred embodiment, the sealing element 130 can be manufactured from a soft material, such as rubber or an elastomer. For example, the sealing element 160 can be manufactured from ethylene propylene diene monomer (EPDM), fluoroelastomer (FKM), a perfluoroelastomer (FFKM), or although other elastomer known. In an alternative embodiment, the sealing element 130 can be manufactured from a fluropolymer resin. The sealing element 130 can include an alignment portion 132, such as an O-ring, for seating grooves 62 of respective pipe fittings 60a, 60b. The sealing element 130 is preferably annular and has a inner diameter (ID) 68 which corresponds substantially to the ID 66 of the pipe fitting 60a, 60b. In some embodiments, the ID 68 of the sealing element 130 may be slightly larger than the ID 66 of the pipe fitting 60a, 60b. In yet another embodiment, the support element 110 and the sealing element 130 can be formed as a unitary piece.

When a hinged clamp 70 is tightened, it acts against tapered outside surfaces of the flanges 61 such that a seal is produced between the flanges 61 and the pipe gasket 100. The support element 110 prevents the sealing element 130 from being destroyed or significantly distorted by over tightening of clamp 70. In instances where the ID 68 of the sealing element 130 is slightly larger than the ID 66 of the pipe fitting 60a, 60b, the sealing element 130 expands radially until the ID 68 of the sealing element 130 substantially equals the ID of the pipe fitting 60a, 60b.

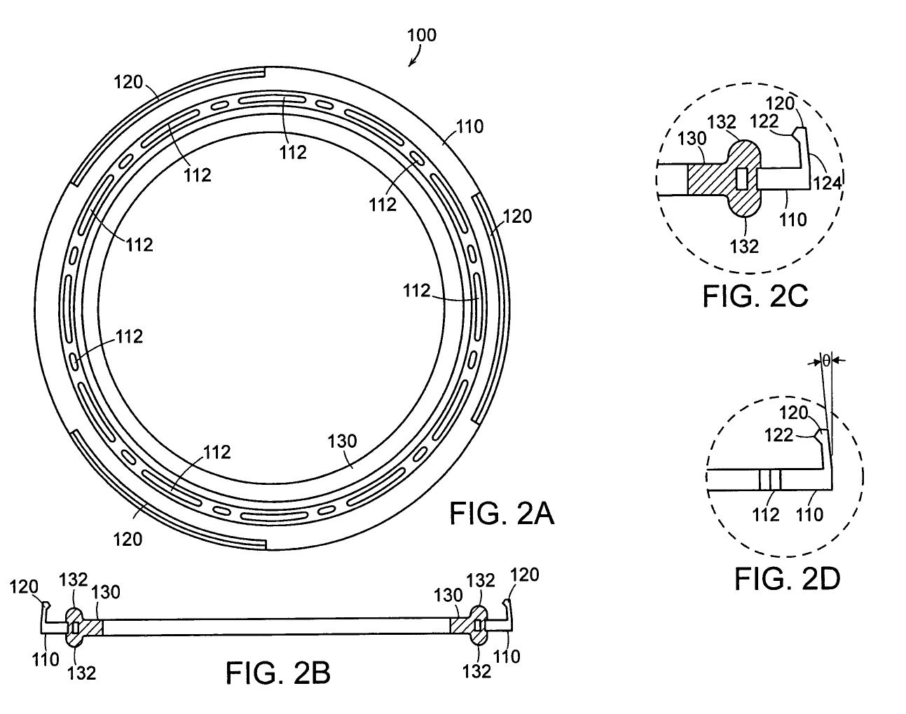

FIGS. 2A-2D show a detailed view of the pipe gasket 100 of the present invention. The support element 110 preferably includes three inwardly directing protrusions 120 about the outer circumference of the support element 110. Preferably, each protrusion 110 is evenly spaced to cooperatively aid in engaging the outer face 64 of either pipe fitting 60a, 60b (FIGS. 1A-1C). In one embodiment, each protrusion extends inwardly approximately at angle θ from the outer circumference of the support element 110. The angle θ is preferably 8 degrees but can range between 1 and 89 degrees. The degree in which the protrusion 120 is facing provides an amount of restoring force when the protrusion 120 is in mechanical connection with the outer face 64 of either pipe fitting 60a, 60b. That is, while each protrusion 120 flexes outwardly in a radial direction when engaging the outer face 64 of either pipe fitting 60a, 60b, a restoration force is applied in an equal but opposite direction which effectively secures the pipe gasket 100 to either pipe fitting 60a, 60b.

In another embodiment, each protrusion 120 has a width of between 1 and 49 percent of the outer circumference of the support element 110 and preferably approximately sixteen percent of the outer circumference of the support element 110.

The width of the protrusion provides a larger contact/surface area for the engaging the outer face 64 of either pipe fitting 60a, 60b. The width also provides a stable surface area 124 for writing indicia representative of the pipe gasket 100. The indicia can include, but is not limited to, material identification of the pipe gasket 100, date and lot code the pipe gasket 100 was made, the type of application of the pipe gasket 100 is approved for, and/or the date the pipe gasket 100 is installed. In yet another embodiment, each protrusion can include an engagement portion or lip 122 for engaging the outer face 64 of either pipe fitting 60a, 60b.

In other embodiments, the support element 110 can be color-coded. The colors can be pre-assigned to aid with preventive maintenance of the pipe joints for a particular application. For example, a plant's protocol or the FDA may require replacement of each pipe gasket 100 every two months. As such, a different color can be assigned for each two month period. Quality control can check the color of the support element 110 of each pipe gasket 100 to determine if each pipe gasket 100 is within the plant's protocol without having to physically open the pipe joint. Further, colors can be assigned for material identification of the pipe gasket 100 and/or the type of application the pipe gasket 100 is approved for.

As shown in FIG. 2A, the support element 110 includes a series of holes 112 that allow the seating element 130 to couple through. Such coupling can include cross-linking, bonding, or any other type of coupling known in the art. In a preferred embodiment, the holes 112 are evenly spaced about the inner circumference of the support element 110. Known pipe gaskets use adhesives that can contaminate the process stream by leaching out or breaking down over time. The present invention eliminates this risk by removing the adhesives.

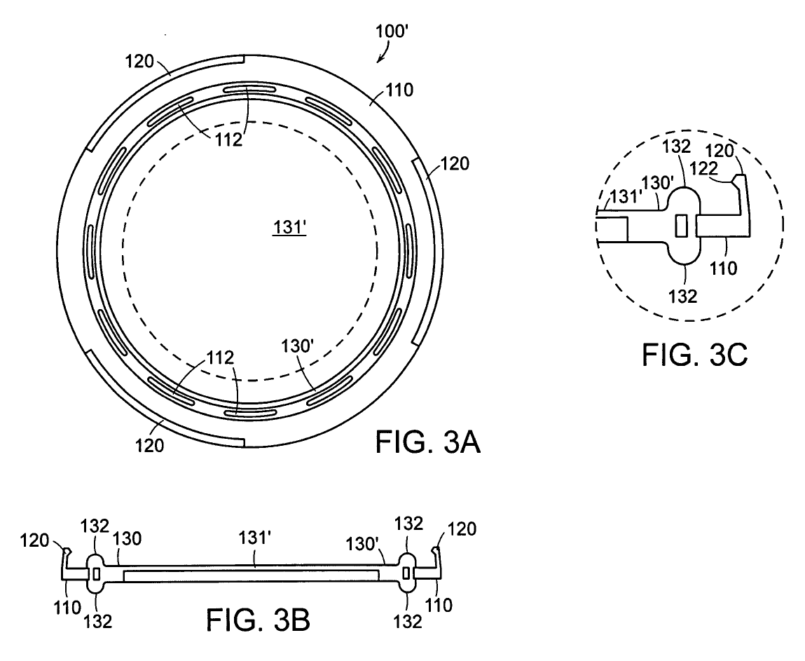

FIGS. 3A-3C show a detailed view of another embodiment of the pipe gasket 100′ of the present invention. Each of the elements are essentially the same as the elements as described in FIGS. 2A-2D. However, sealing element 130 has been replaced with sealing element 130′. Sealing element 130′ provides a gasket membrane 131′ that protects instrumentation from caustic saline solutions. For example, the pipe gasket 100′ can be used to couple a pressure gauge to the piping system. The gasket membrane 131′ will not interfere with gauge operation or accuracy, the gasket membrane 131′ will work with most industry standard instruments, and the gasket membrane 131′ will help extend the life of gauges.

The orientation of the support element 120 provides accurate installation of the pipe gasket 100′. As shown in FIGS. 3B and 3C, the protrusions 120 are on the same side as the gasket membrane 131′. Improper installation of the pipe gasket 100′ will cause the gasket membrane 131′ to fail, thereby allowing potential damage to the gauges.

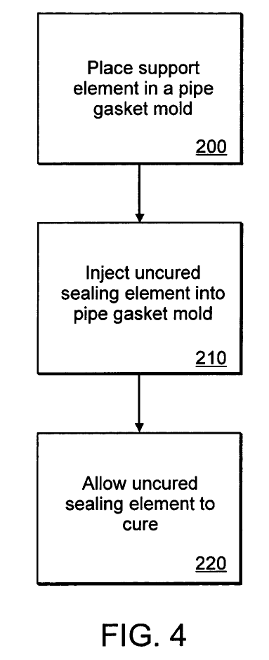

FIG. 4 shows a flow diagram of one embodiment of manufacturing a pipe gasket 100 of the present invention. In a first step (200), the support element 120 is placed in a pipe gasket mold. Next (210), an uncured sealing element is injected into the pipe gasket mold such that the pressure in the mold allows the uncured sealing element to flow through a plurality of holes in the support element. After which (220), the uncured sealing element is allowed to cure thereby coupling itself to the support element.

While this invention has been particularly shown and described with references to preferred embodiments thereof, it will be understood by those skilled in the art that various changes in form and details may be made therein without departing from the scope of the invention encompassed by the appended claims.

What is claimed is:

1. A pipe gasket for providing a seal between a pair of pipes, each pipe including a pipe flange having a grooved face and an outer face, comprising:
a support element having at least two protrusions extending from an outer circumference toward an inner circumference, each protrusion for cooperatively engaging the outer face of one pipe flange; and
a sealing element coupled to the support element to provide a fluid tight seal between the pair of pipes.

2. The pipe gasket of claim 1, wherein the support element defines a plurality of holes in close proximity to the inner circumference, respective outer portions of the sealing element couple through the holes.

3. The pipe gasket of claim 2, wherein the holes are evenly spaced around the inner circumference of the support element.

4. The pipe gasket of claim 1, wherein the support element includes three inwardly directing protrusions.

5. The pipe gasket of claim 4, wherein each protrusion is substantially evenly spaced about the outer circumference of the support element.

6. The pipe gasket of claim 4, wherein each protrusion has a width between one and forty-nine percent of the outer circumference of the support element.

7. The pipe gasket of claim 6, wherein the width of each protrusion is approximately sixteen percent of the outer circumference of the support element.

8. The pipe gasket of claim 1, wherein each protrusion extends inwardly between one and eighty-nine degrees from the outer circumference of the support element.

9. The pipe gasket of claim 8, wherein each protrusion extends inwardly approximately eight degrees.

10. The pipe gasket of claim 1, wherein each protrusion includes an engagement portion for engaging an outer face of at least one of the pipe flanges.

11. The pipe gasket of claim 1, wherein the support element is metal or plastic.

12. The pipe gasket of claim 1, wherein the support element is color-coded.

13. The pipe gasket of claim 1, wherein the sealing element includes an alignment portion for aligning respective grooved faces of each pipe flange.

14. The pipe gasket of claim 13, wherein the alignment portion is an O-ring.

15. The pipe gasket of claim 1, wherein the sealing element is an elastomer.

16. The pipe gasket of claim 15, wherein the elastomer is an ethylene propylene diene monomer, a fluoroelastomer, or a perfluoroelastomer.

17. The pipe gasket of claim 1, wherein the protrusions include a surface for placing indicia representative of the pipe gasket.

18. The pipe gasket of claim 1, wherein the sealing element includes a membrane.

19. A method of forming a pipe gasket, comprising:
placing a support element in a pipe gasket mold, the support element defining a plurality of holes in close proximity to the inner circumference;
injecting an uncured sealing element into the pipe gasket mold; and
curing the uncured sealing element allowing respective outer portions of the sealing element to couple through the holes.

20. The method of claim 19, wherein the sealing element is an elastomer.

21. The method of claim 19, wherein the support element is color-coded.

22. The method of claim 19, wherein the sealing element includes an alignment element for aligning with respective grooved faces of a pair of pipe flanges.

23. A pipe gasket for providing a seal between a pair of pipes, each pipe including a pipe flange having a grooved face and an outer face, comprising:
a support element having at least two protrusions extending from an outer circumference toward an inner circumference, each protrusion for cooperatively engaging the outer face of one pipe flange, wherein the support element includes a sealing element to provide a fluid tight seal between the pair of pipes.

24. A pipe gasket for providing a seal between a pair of sanitary pipes, each pipe including a pipe flange having a grooved face and an outer face, comprising:
means for cooperatively engaging an outer face of at least one of the pipe flanges; and
means for providing a fluid tight seal between the pair of sanitary pipes.
